(19) United States
(12) Patent Application Publication
(10) Pub. No.: US 2026/0217907 A1
(43) Pub. Date: Jul. 30, 2026

(54) BIO-BASED AND COMPOSTABLE ELASTOMERIC MATERIALS, METHODS OF MANUFACTURE AND ARTICLES AND USES THEREOF

(71) Applicant: BIOASTRA TECHNOLOGIES INC., Montreal (CA)

(72) Inventors: Sumitra RAJAGOPALAN, Montreal (CA); Oscar SUAREZ, Montreal (CA); Prajwal KUMAR, Montreal (CA); Alexei TOKAREV, Montreal (CA); Nicolas COTTENYE, Montreal (CA); Milad HADAEGHNIA, Montreal (CA); Mohamed ZEMZEM, Saint-Laurent (CA)

(21) Appl. No.: 19/141,559

(22) PCT Filed: Dec. 21, 2023
(86) PCT No.: PCT/CA2023/051734

§ 371 Date: Jun. 20, 2025

Related U.S. Application Data
(60) Provisional application No. 63/434,257, filed on Dec. 21, 2022.

(51) Int. Cl. C08G 63/60; C08G 63/52; C08J 9/00; C08J 9/08; C08K 3/34; C08K 5/103; C08L 1/12; C08L 67/04; C08L 67/06; C08L 75/04; C08L 83/04; D01D 5/08; D01D 10/00; D01F 1/10; D01F 6/84

(52) U.S. Cl. CPC C08G 63/60; C08G 63/52; C08J 9/0023; C08J 9/0061; C08J 9/08; C08K 3/346; C08K 5/103; C08L 1/12; C08L 67/04; C08L 67/06; C08L 75/04; C08L 83/04; D01D 5/08; D01D 10/00; D01F 1/10; D01F 6/84; C08G 2230/00; C08J 2203/02; C08J 2301/12; C08J 2467/04; C08J 2467/06; C08L 2201/06; C08L 2203/12; C08L 2203/14; C08L 2203/30; D10B 2401/061; D10B 2401/063; D10B 2401/12; D10B 2505/08

(57) ABSTRACT

There are provided compositions, systems and methods to fabricate bio-based and biodegradable elastic materials in the form of fibers, foams and molded objects, as well as various articles made using the same. The elastic materials consist primarily of di-acids and di-alcohols with or without crosslinkers and supporting polymer structures.

### CROSS-REFERENCE TO RELATED APPLICATIONS

This application claims the benefit of priority from U.S. Provisional Application No. 63/434,257 filed Dec. 21, 2022, which is incorporated by reference herein in its entirety.

### FIELD

The disclosure relates to bio-based and compostable elastic materials, methods for preparation of the materials, and applications thereof. The elastic materials are polymers made of di-acids and di-alcohols, with or without crosslinkers, and supporting polymer structures.

### BACKGROUND

Polyurethane, including elastane which is better known commercially as spandex, is a class of polymers possessing superior tensile and elongation properties and ranging from hard resins to highly elastic sponge-like materials. It is found in a variety of formats from fibers to foams and used in wide-ranging applications, from bed mattresses to stretchable pants and automobile interiors. However, elastane and polyurethanes in general, are hard to recycle in standard curbside facilities, and their constituent moieties are neither biodegradable nor compostable. Furthermore, isocyanate, one of the crosslinker molecules commonly used in elastane and polyurethanes in general, is a known toxin.

Previously, compostable elastomers such as polybutylene adipate terephthalate (PBAT) have been made. However, these polymers are highly stiff with a low elongation ratio and are not suitable for soft elastomeric applications such as textiles and packaging. Further, the source molecules are petrochemical based.

Citric acid-based elastomers are well known as well. However, these elastomers suffer from several drawbacks including their brittleness, weak mechanical properties, long curing times and most importantly, their inability to be processed into fibers, resins or foams.

There is a need for a compostable elastomer that is made from non-toxic, bio-based materials without compromising its physical properties or performance characteristics.

### SUMMARY

The present disclosure relates generally to biodegradable and compostable elastomeric materials which are made from bio-based materials and possess desirable performance tensile and elongation properties. In some embodiments, elastomeric materials produced in accordance with the methods provided herein can overcome the limitations of the prior art. An object of the present disclosure is to provide elastic materials that preserve the performance and process attributes of polyurethanes and elastane while changing the chemical composition to a 100% bio-based and compostable material. Composition and process parameters described herein have been chosen to maximise tensile properties, including elongation ratio, while also creating a unique blend of thermoplastic bio-polymers with a crosslinked polymer that allows melt processability and thermoformability.

In a first broad aspect of the present disclosure, elastomeric properties are achieved by using a bio-based crosslinker such as glycerol or citric acid to bring together a bio-alcohol and a bio-acid.

In a second broad aspect of the present disclosure, elastomeric properties are achieved using a linear polymer consisting of a bio-based and compostable di-alcohol which is made to react with a di-acid to form a bio-polyester. Copolymers consisting of rigid segments like terephtalic acid and soft segments like poly(ethylene glycol) also possess high elongation ratios with full elastic recovery after stretching.

In a third broad aspect of the present disclosure, elastomeric properties are achieved using a linear polymer consisting of a bio-based and compostable di-alcohol which is made to react with a di-acid to form a bio-polyester in the presence of a crosslinking agent which contains both a thermal initiator and a photoinitiator. In some such embodiments, the crosslinking agent contains 2 reactive sites: one which is thermally activated, either prior to extrusion or inside an extruder, and one which is UV activated, e.g., by exposure to UV light, e.g., after extrusion. Non-limiting examples of such crosslinking agents include itaconic acid, maleic acid, maleic anhydride, ands combinations thereof. Without wishing to be limited by theory, the use of such crosslinking agents allows extrusion (fibers and foams can be extruded since the crosslinking agent does not thermoset like other crosslinking agents, such as citric acid), with cross-linking activated by UV light outside the extruder (i.e., after extrusion). Such fibers and foams can have advantageous properties such as, for example and without limitation: high elongation, e.g., elongation ratio of at least 50%, at least 200%, of up to 600%; of up to 1000%, or of about 200%; high tenacity, e.g., a tenacity of at least 0,6-5 g/denier; denier size of about 25 to about 40, of about 25, of at least 25, of about 40 or of at least 40; full elastic recovery after stretching; and combinations thereof.

In some embodiments, there is provided a bio-based and compostable stretchable polymer made from reacting one or more di-alcohol(s) with a di acid or tri-acid, followed by curing at high temperatures. In some embodiments, the di-alcohol is 1.4 butanediol, pentanediol, hexanediol, octanediol, decanediol or dodecanediol. In some embodiments, the di-acid is sebacic acid, succinic acid, adipic acid, lactic acid, or boric acid. In some embodiments, the stretchable polymer further comprises a crosslinking agent such as, without limitation, citric acid or boronic acid. In some embodiments, the stretchable polymer further comprises a crosslinking agent such as, without limitation, is itaconic acid, maleic acid, maleic anhydride, or a combination thereof. In some embodiments, the stretchable polymer further comprises a reinforcing agent added to improve stiffness and/or resistance to breaking, such as, without limitation, microcrystalline cellulose, nanocrystalline cellulose, titanium dioxide, kaolin, silica, nanoclays, carbon black, or a combination thereof. In some embodiments, the stretchable polymer is blended with a carrier polymer, e.g., to obtain a desired viscosity and/or consistency, e.g., suitable for processing into fibers or foams. Non-limiting examples of carrier polymers include cellulose, cellulose derivatives, poly(lactic acid), polycaprolactam, starch, and other biopolymers.

In some embodiments, the bio-based and compostable stretchable polymer demonstrates an elongation ratio of at least 50%, at least 200%, of up to 600%; or of up to 1000%.

In some embodiments, the bio-based and compostable stretchable polymer has a tenacity of at least 5 g/denier.

In some embodiments, the bio-based and compostable stretchable polymer fiber has a denier size of about 25. In some embodiments, the bio-based and compostable stretchable polymer fiber has a denier size of about 40. In some embodiments, the bio-based and compostable stretchable polymer fiber has a denier size of about 25 to about 40.

In some embodiments, the bio-based and compostable stretchable polymer can recover its original length fully upon removal of stress.

In some embodiments, the bio-based and compostable stretchable polymer can undergo at least 100 cycles of relaxation and elongation without any fatigue.

In some embodiments, the bio-based and compostable stretchable polymer is suitable for processing into fibers, e.g., via melt spinning, solution spinning, electrospinning or melt blowing. Fibers may have dimensions of, for example, from 50 to 150 deniers. Fibers can generally be woven or knit with cotton, polyester or other fibers to form a stretch fabric.

In some embodiments, there is provided a stretch fabric comprising the bio-based and compostable stretchable polymer described herein. In some such embodiments, the stretch fabric remains intact with no loss of mass or physical properties after 25 wash, rinse and drying cycles.

In some embodiments, there is provided a knit or woven fabric comprising the bio-based and compostable stretchable polymer described herein. In some such embodiments, the knit or woven fabric further comprises cotton, polyester, nylon, or a combination thereof.

In some embodiments, the bio-based and compostable stretchable polymer is suitable for being molded into objects, e.g., via injection molding or 3D printing. For example, bio-based and compostable stretchable polymers of the disclosure can be made into cellular structures or foams through introduction of blowing agents. In some embodiments, the bio-based and compostable stretchable polymer is thermoformable at elevated temperatures.

In some embodiments, the bio-based and compostable stretchable polymer is made partially or entirely of plant-derived molecules.

In some embodiments, the bio-based and compostable stretchable polymer is fully biodegradable at the end of its life.

In some embodiments, the bio-based and compostable stretchable polymer is fully compostable at the end of its life.

In some embodiments, the bio-based and compostable stretchable polymer is fully recyclable at the end of its life. In some such embodiments, the polymer can be broken into its constituent monomers by an increase in pH, and the monomers can then be recovered and re-spun into a new fiber.

In some embodiments, the bio-based and compostable stretchable polymer can be separated from a blend via an increase in pH. The increase in pH may, for example, cause hydrolysis of the polymer into its monomers, which can then be further reacted to form a new polymer, thereby promoting recycling. In some such embodiments, the pH is increased to pH of about 11 to about 13, or to pH of 11, pH of 12, or pH of 13.

In some embodiments, the bio-based and compostable stretchable polymer is suitable for use in place of fibers, for example in garments, undergarments, automobile interiors, medical textiles and/or wound dressings.

In some embodiments, the bio-based and compostable stretchable polymer is suitable for use in place of polyurethane foam, for example in insulation, packaging and garment applications.

In some embodiments, the bio-based and compostable stretchable polymer is suitable for use in place of poly(dimethyl silicone) in molded elastomeric objects, for example in phone cases, sealants, or household items such as, without limitation, bed mattresses or furniture.

In some embodiments, the bio-based and compostable stretchable polymer comprises polyglycerol sebacate (PGS) or polyoctanediol citrate (POC):

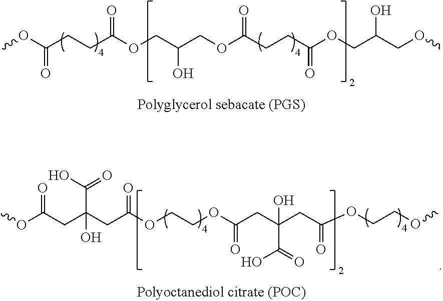

In some embodiments, the bio-based and compostable stretchable polymer comprises a carrier polymer which is cellulose acetate (CA):

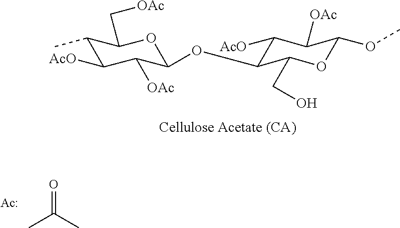

In some embodiments, there is provided a foam comprising the bio-based and compostable stretchable polymer described herein. In some embodiments, foams of the disclosure further comprise a surfactant, such as without limitation castor oil, which can increase density and/or uniformity of the foam.

In some embodiments, there is provided a molded object comprising the bio-based and compostable stretchable polymer described herein.

In some embodiments, there is provided a fiber comprising the bio-based and compostable stretchable polymer described herein.

In some embodiments, there is provided an article comprising the bio-based and compostable stretchable polymer described herein. Non-limiting examples of such articles include garments, undergarments, woven fabrics, knit fabrics, stretch fabrics, automobile interiors, medical textiles, wound dressings, insulation, packaging, phone cases, sealants, household items, bed mattresses, furniture, and the like.

In an embodiment, there is provided a biodegradable, compostable, and bio-based elastomeric fiber which has an elongation ratio of at least 50%, up to 600%, or up to a maximum elongation ratio of 1000%; can recover its original length fully upon removal of stress; and can undergo at least 100 cycles of relaxation and elongation without any fatigue. In some such embodiments, the elastomeric fiber has a tenacity of at least 5 g/denier. In some such embodiments, the elastomeric fiber has a denier size of at least about 40. In some such embodiments, the elastomeric fiber comprises a di-alcohol reacted with a di acid or tri-acid and cured at high temperatures. In some such embodiments, the elastomeric fiber comprises polyglycerol sebacate (PGS) or polyoctanediol citrate (POC), and optionally further comprises a carrier polymer which is cellulose acetate (CA). In other embodiments, the elastomeric fiber comprises a di-alcohol reacted with a di acid in the presence of a crosslinking agent comprising both a thermal initiator and a photoinitiator, and formed by extrusion followed by curing with UV. In some such embodiments, the crosslinking agent is itaconic acid, maleic acid or a combination thereof. In some such embodiments, a plurality of di-alcohols and di-acids are esterified together (i.e., in the first step). Such esterification can prevent crystallization and/or maximise elongation of the fiber. Non-limiting examples of di-alcohols for use in such embodiments include propandiol and/or 1,4 butanediol. Non-limiting examples of di-acids for use in such embodiments include sebacic acid and/or succinic acid.

In another aspect, there are provided methods of making the bio-based and compostable stretchable polymers of the description. In one embodiment, octanediol, sebacic acid and citric acid are combined equimolarly and melt at 80 degrees C. to a honey-like consistency. Thereafter, cellulose acetate is separately plasticised with triethyl citrate and combined with the molten precursors. The resulting melt is passed through an extruder and a spinneret and drawn into fibers (see FIG. 1).

In another embodiment, a partially cured poly(octanediol citrate sebacate) containing baking soda is hot pressed with cellulose acetate mold into a certain shape. Upon heating, the baking soda reacts with citric acid to create pores and hence a foam structure. The resulting material can be incorporated into a wide variety of articles, such as, for example and without limitation, shoes, garments and other apparel.

In an embodiment, the method comprises: combining equimolar amounts of octanediol, sebacic acid and citric acid and melting at 80 degrees C. to a honey-like consistency, to form a molten precursor; plasticizing cellulose acetate with triethyl citrate and combining with the molten precursor, to form a melt; and passing the melt through an extruder and a spinneret and drawing into fibers.

In another embodiment, the method comprises: combining equimolar amounts of octanediol, sebacic acid and citric acid and melting at 80 degrees C. to form a partially cured poly(octanediol citrate sebacate); hot pressing the partially cured poly(octanediol citrate sebacate) containing baking soda with a cellulose acetate mold into a desired shape; and heating so that the baking soda reacts with the citric acid to create pores, thereby forming a foam structure.

In another embodiment, the method comprises: reacting a plurality of diacids and dialcohols together in the presence of a crosslinking agent to form a polyester, wherein the crosslinking agent comprises both a thermal initiator and a photoinitiator; pelletising the polyester and then melting or solution extruding the pelleted polyester to form a thermoplastic fiber; and exposing the thermoplastic fiber to a UV chamber for a time sufficient (e.g., at least a few minutes) to activate an unsaturated double bond in the crosslinking agent and create a crosslink, thereby producing the elastomeric fiber. In some such embodiments, said reacting comprises esterifying the plurality of di-acids and di-alcohols together, e.g., to prevent crystallization and/or maximise elongation. In some such embodiments, the di-alcohols comprise propandiol, 1,4 butandiol, or a combination thereof. In some such embodiments, the di-acids comprise sebacic acid, succinic acid, or a combination thereof.

In some embodiments, the bio-based and compostable stretchable polymer further comprises a UV stabilizer such as boric acid.

In some embodiments, the bio-based and compostable stretchable polymer further comprises a thermal stabilizer such as lignin.

In an embodiment, there is provided a stretchable polymer which provides a sustainable alternative to or replacement for elastane. In some such embodiments, the stretchable polymer is composed entirely of natural biomolecules, e.g., 100% bio-based and compostable.

In an embodiment, there is provided a bio-based and compostable stretchable polymer.

In an embodiment, there is provided a bio-based and compostable stretchable polymer which has an elongation ratio of 200%.

In an embodiment, there is provided a bio-based and compostable stretchable polymer which has an elongation ratio of up to 600%.

In an embodiment, there is provided a bio-based and compostable stretchable polymer which has a tenacity of at least 5 g/denier.

In an embodiment, there is provided a bio-based and compostable stretchable fiber which has a denier size of about 25 to about 40, about 25, or about 40.

In an embodiment, there is provided a bio-based and compostable stretchable polymer which has full elastic recovery.

In an embodiment, there is provided a bio-based and compostable stretchable polymer which is stable through multiple wash cycles.

In an embodiment, there is provided a bio-based and compostable stretchable polymer which can be processed via adapted melt spinning.

In an embodiment, there is provided a bio-based and compostable stretchable polymer formed by extrusion, following by curing with UV light.

In an embodiment, there is provided a bio-based and compostable stretchable polymer that can be formed as ultra thin fibers (e.g., fibers of at least 40 denier), e.g., via melt or dry spinning.

In an embodiment, there is provided a bio-based and compostable stretchable polymer which can be easily separated from a blend at end of life via mild hydrolysis. For example and without limitation, an increase in pH can cause hydrolysis of the polymer into its monomers. Recovered monomers can further react to form a new polymer and can be reprocessed into fibers without degradation, thereby promoting recycling.

Fibers, foams, and molded objects comprising the bio-based and compostable stretchable polymers of the disclosure are also provided.

Articles comprising the bio-based and compostable stretchable polymers of the disclosure, as well as fibers, foams, and molded objects thereof, are also provided.

More aspects and features of the technology are described in the detailed description below.

### BRIEF DESCRIPTION OF THE DRAWINGS

The patent or application file contains at least one drawing executed in colour. Copies of this patent or patent application publication with colour drawing(s) will be provided by the Office upon request and payment of the necessary fee.

For a better understanding of the invention and to show more clearly how it may be carried into effect, reference will now be made by way of example to the accompanying drawings, which illustrate aspects and features according to embodiments of the present invention, and in which:

FIG. 1 is a schematic diagram showing a protocol for preparing a bio-elastomer, in accordance with certain embodiments of the technology.

FIG. 2 shows a graph of Stress at 50% strain (MPa) vs. Cycle for test bio-elastomers OS-GE07 (bottom line, orange) and OS-GE08 (top line, green), indicating the maximum force applied during each cycle to reach 50% strain (n=3).

FIG. 3 shows a graph of strain at 0 MPa (%) vs. Cycle for test bio-elastomer OS-GE07, indicating the non-recovered elongation leftover at the start of each cycle (n=3).

FIG. 4 is a schematic diagram showing a method for fabricating a Foam from a bio-elastomer, in accordance with certain embodiments.

FIG. 5 is a photograph showing a bio-foam produced from a bio-elastomer, in accordance with certain embodiments.

FIG. 6 shows photographs of bio-foams produced from bio-elastomers of the disclosure, in accordance with certain embodiments. Foams pictured are, from left to right, Foam 1, Foam 2, Foam 3, Foam 4, and Foam 5.

### DETAILED DESCRIPTION

The terminology used in the description of the various described embodiments herein is for the purpose of describing particular embodiments only and is not intended to be limiting.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this invention pertains.

### Definitions

As used herein, the use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used herein, the words “comprising” (and any form of comprising, such as “comprise” and “comprises”), “having” (and any form of having, such as “have” and “has”), “including” (and any form of including, such as “include” and “includes”) and “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

As used herein, when content is indicated as being present on a “weight basis” or at a “weight percent (wt %)” or “by weight,” the content is measured as the percentage of the weight of component(s) indicated by dry basis (by taking moisture percentage in each component into account), relative to the total weight of all components present in a composition.

The term “derivative” as used herein, is understood as being a substance similar in structure to another compound but differing in some slight structural detail.

As used herein, the term “polymer” refers to a material that includes a set of macromolecules. Macromolecules included in a polymer can be the same or can differ from one another in some fashion. A macromolecule can have any of a variety of skeletal structures, and can include one or more types of monomeric units. In particular, a macromolecule can have a skeletal structure that is linear or non-linear. Examples of non-linear skeletal structures include branched skeletal structures, such those that are star branched, comb branched, or dendritic branched, and network skeletal structures. A macromolecule included in a homopolymer typically includes one type of monomeric unit, while a macromolecule included in a copolymer typically includes two or more types of monomeric units. Examples of copolymers include statistical copolymers, random copolymers, alternating copolymers, periodic copolymers, block copolymers, radial copolymers, and graft copolymers.

In some instances, a reactivity and a functionality of a polymer can be altered by addition of a set of functional groups, such as acid anhydride groups, amino groups and their salts, N-substituted amino groups, amide groups, carbonyl groups, carboxy groups and their salts, cyclohexyl epoxy groups, epoxy groups, glycidyl groups, hydroxy groups, isocyanate groups, urea groups, aldehyde groups, ester groups, ether groups, alkenyl groups, alkynyl groups, thiol groups, disulfide groups, silyl or silane groups, groups based on glyoxals, groups based on aziridines, groups based on active methylene compounds or other b-dicarbonyl compounds (e.g., 2,4-pentandione, malonic acid, acetylacetone, ethylacetone acetate, malonamide, acetoacetamide and its methyl analogues, ethyl acetoacetate, and isopropyl acetoacetate), halo groups, hydrides, or other polar or H bonding groups and combinations thereof. Such functional groups can be added at various places along the polymer, such as randomly or regularly dispersed along the polymer, at ends of the polymer, on the side, end or any position on the crystallizable side chains, attached as separate dangling side groups of the polymer, or attached directly to a backbone of the polymer. Also, a polymer can be capable of cross-linking, entanglement, or hydrogen bonding in order to increase its mechanical strength or its resistance to degradation under ambient or processing conditions.

“Polymerization” is a process of reacting monomer molecules together in a chemical reaction to form three-dimensional networks or polymer chains. Many forms of polymerization are known, and different systems exist to categorize them, as are known in the art.

As can be appreciated, a polymer can be provided in a variety of forms having different molecular weights, since a molecular weight (MW) of the polymer can be dependent upon processing conditions used for forming the polymer. Accordingly, a polymer can be referred to as having a specific molecular weight or a range of molecular weights. As used herein with reference to a polymer, the term “molecular weight (MW)” can refer to a number average molecular weight or a weight average molecular weight. Polymers are often referred to in terms of their average MW, for example PEG1000 refers to PEG of average MW of 1000. Polymers may also be referred to in terms of their degree of polymerization (“n”), which can range, generally, from as low as 40 to as high as 5000. In some cases, polymers of different molecular weights may be mixed to give a composition having desired properties. It should be understood that polymers of any molecular weight, or mixtures of polymers of different molecular weights, may be used, as long as the resulting composition has the desired properties or is generally suitable for the uses described herein, as will be determined by the skilled artisan using known techniques.

As used herein, the term “copolymer” refers to polymers having two or more different divalent monomer units.

As used herein, the term “chemical bond” refers to a coupling of two or more atoms based on an attractive interaction, such that those atoms can form a stable structure. Examples of chemical bonds include covalent bonds and ionic bonds. Other examples of chemical bonds include hydrogen bonds and attractive interactions between carboxy groups and amine groups. As used herein, the term “covalent bond” means a form of chemical bonding that is characterized by the sharing of pairs of electrons between atoms, or between atoms and other covalent bonds. Attraction-to-repulsion stability that forms between atoms when they share electrons is known as covalent bonding. Covalent bonding includes many kinds of interactions, including sigma-bonding, pi-bonding, metal-metal bonding, agostic interactions, and three-center two-electron bonds.

As used herein, the term “reactive function” means a chemical group (or a moiety) capable of reacting with another chemical group to form a covalent or an electrovalent bond, examples of which are given above. Preferably, such reaction is doable at relatively low temperatures, e.g. below 200° C., more preferably below 100° C., and/or at conditions suitable to handle delicate substrates, e.g. textiles. A reactive function could have various chemical natures. For example, a reactive function could be capable of reacting and forming electrovalent bonds or covalent bonds with reactive functions of various substrates, e.g., cotton, wool, fur, leather, polyester, or textiles made from such materials, as well as other base materials.

As used herein, the term “compostable” refers to organic matter that breaks down completely into non-toxic components (e.g., water, carbon dioxide, and biomass) by biological processes during composting and that does not harm the environment, i.e., leaves no toxic residue. As used herein, the term “biodegradable” means a material that breaks down and decomposes in the environment. While all compostable material is biodegradable, not all biodegradable material is compostable. Unlike compostable items which don't leave toxic residue behind because they are already organic, certain biodegradable products can take several years to break down and in some cases can leave toxic waste behind.

As used herein, the term “bio-based” refers to materials made from substances derived from organic matter, i.e., biomaterials, plants or other renewable agricultural, marine, and forestry materials.

### EXAMPLES

The present invention will be more readily understood by referring to the following examples, which are provided to illustrate the invention and are not to be construed as limiting the scope thereof in any manner.

Unless defined otherwise or the context clearly dictates otherwise, all technical and scientific terms used herein have the same meaning as commonly understood by one of ordinary skill in the art to which this invention belongs. It should be understood that any methods and materials similar or equivalent to those described herein can be used in the practice or testing of the invention.

### Example 1. Separation Testing via pH Change

Objectives. Tests were conducted to determine the minimum conditions for bio-elastomer depolymerization; verify that increasing the surface area leads to a quicker degradation; verify that the degradation conditions don't affect cotton and polyester; and assess the effect of home laundry detergents on the bio-elastomer.

Materials. The following materials were used: Bio-elastomer: OS-GE07-3; 3 bulk pieces: (127±2 mg) prisms, approximately 6× 4× 2 mm; long piece: 128 mg strip, approximately 40×1× 1 mm; Fabrics: cotton (130 mg simple woven fabric, approximately 2×2 cm), PE (80% polyester, 20% Nylon, 165 mg complex woven fabric, approximately 2×2 cm); Testing solutions: pH 13 buffer (K₂HPO₄ 0.1 M adjusted with NaOH (pH 13.3)), pH 12 buffer (Na₂CO₃ 0.1 M (pH 11.8); and detergent: Arm & Hammer cold-wash laundry detergent diluted 1:50 (pH 11.2).

Samples are shown in Table 1.

TABLE 1
Samples.

| Label | Sample | Mass (mg) | Solution |
|---|---|---|---|
| A1 | bulk bio-elastomer | 127 | pH 13.3 buffer |
| A2 | long bio-elastomer | 128 | pH 13.3 buffer |
| A3 | Cotton | 130 | pH 13.3 buffer |
| B1 | bulk bio-elastomer | 125 | pH 11.8 buffer |
| C1 | bulk bio-elastomer | 129 | detergent |
| PE | PE | 165 | pH 13.3 buffer |

Tests. For the first test, A, B, and C samples were placed into their testing solution and the samples were left at room temperature for 2 hours. The samples were inspected and stirred every 30 minutes (“Room Temperature test”). After the first test, the same test tubes were transferred to a water bath at 90° C. for 1.5 hours. The samples were inspected and stirred every 30 minutes (“High Temperature test”). As an additional test on the following day, a piece of PE/Nylon fabric was put into the pH 13.3 buffer and stored at 55° C. for 3 hours. The sample was removed and inspected at the 1-hour mark and the test was then continued (“Polyester test”).

Results for the Room Temperature test. The bio-elastomer (samples A1, A2) turned yellow soon after entering the pH 13.3 solution. They did not appear to be otherwise affected. The samples had gained weight after their surface was dried, which might be due to the absorption of water, or to the phenomenon that created the yellow colouring. The long and thin sample (A2) gained more weight than A1 (41% v. 18%), which suggested a surface-dependent effect. The piece of cotton (sample A3) wasn't affected by the test. The bio-elastomer (B1) didn't change when it was put in the pH 11.8 solution. By the end of the 2-hour test, it had a slight yellow tint, and had gained a little weight (8%). The bio-elastomer (C1) did not appear to have been affected by the room-temperature laundry detergent.

Results for the High Temperature test. The bio-elastomer (samples A1, A2) dissolved completely in the pH 13.3 solution at 90° C. after about 45 minutes for the thin sample (A2) and 1.5 hours for the bulk sample (A1). The piece of cotton (A3) wasn't affected by the test. The bio-elastomer (B1) swelled and turned transparent during the test. After removal from the solution, B1 had gained a lot of weight (180%). On the following day, B1 had shrivelled, turned slightly yellow, and lost weight down to 45% of its initial weight. The bio-elastomer (C1) swelled and became whiter. After removal, it was spongy and sticky, with a weight gain of 24%. On the following day, the C1 sample was back to its original weight, with a slightly whiter colour.

Results for the Polyester test. The polyester sample was unaffected by the test.

Analysis. There was no observable effect from submitting cotton or polyester to the degradation conditions. At 90° C. in pH 13.3, there was complete dissolution of the bio-elastomer. The time necessary depended on the geometry, with higher surface areas leading to quicker dissolution. At 90° C. in pH 11.8, there was degradation of the bio-elastomer, but it was slower than at pH 13.3. The bio-elastomer seemed unaffected by the laundry detergent at room temperature. At 90° C., we did observe some interactions between the samples. The bio-elastomer did absorb some water, especially at higher pH and temperatures, and this water evaporated when resting in ambient conditions.

### Example 2. Bio-Elastomer Preparation

Introduction. The biodegradable elastomer prepared herein is based on a family of biodegradable polyesters and represents a new generation of synthetic biomaterials. It includes highly biocompatible and biodegradable components such as citric acid (CA) and sebacic acid (SA). When these multifunctional acids react with multifunctional alcohols in catalyst-free polyesterification reactions, they yield polyesters with high degrees of elasticity.

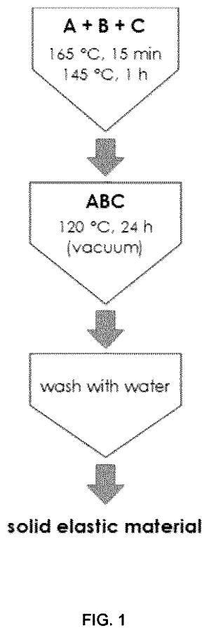

Protocol. The protocol for bio-elastomer preparation is shown schematically in FIG. 1. Components A, B and C were mixed in a vessel according to their respective molar amount. The vessel was placed in a 165° C. oil bath for 15 min to ensure that all the components were melted. The reaction temperature was lowered to 145° C. and the mixture was stirred gently for 1 h. The hot mixture was transferred to a silicone pan and placed in a 120° C. vacuum oven for 20 to 24 h. The obtained bio-elastomer was washed several times with water to remove unreacted monomers.

### Example 3. Bio-Elastomer Characterization

Spandex reference. It is an object of the present technology to replace conventional spandex (e.g., elastane, Lycra™) with a biodegradable, bio-based elastomer. Spandex is a polyurethane-based fiber mostly produced by melt or solvent spinning from macro glycols and cyclic diisocyanates. Its physical properties can be adjusted by the components used.

A typical, conventional spandex monofilament can display the following properties: elongation at break of 200 to 550%; tenacity of 0.9 g/denier; elastic modulus of 0.05 g/denier; 95% strain recovery over cycles at 100% elongation; 10% hysteresis at rest after 5 cycles at 200% elongation; and/or permanent deformation of 10 to 17% after 50,000 cycles.

Testing procedures. Bio-elastomers were tested as described here.

Tensile measurements were made using an Instron universal testing machine equipped with a 50 N loading cell. Specimens were cut into straight segments approximately 4 mm wide, 1.5 mm thick, and 10 cm long. The specimens were held by two 25 mm clamps placed 30 mm apart. Tensile load was measured while extending the material at a constant 50 mm/min. Tensile stress, tensile strain, and Young's modulus were calculated using the Instron Blue Hill™ software.

Elastic recovery was assessed by measuring 10 consecutive extension-relaxation cycles. The specimen was extended at 100%/min up to 50% strain, and then allowed to relax at the same rate back to 0%. The maximum tensile stress for each cycle was recorded.

Physical properties. Tensile properties, cyclability, and elastic recovery were assessed.

(1) Tensile properties. Tensile measurements of both lab-scale OS-GE07 and OS-GE08 showed elastic properties in par with expected bracket from initial specifications (above 100%). OS-GE08 is similar to OS-GE07 but cured 25% more. OS-GE07 could be stretched further, while the OS-GE08 took more tension to stretch. Combining components from these materials will allow performance to be modulated. With the extension of the soft segment length we observed a direct correlation between segment length, tensile strength at yield, and Young's modulus. Results are given in Table 2.

TABLE 2
Tensile properties measured for lab-scale samples (n = 3).

| | Young's modulus | Tensile stress | Tensile strain |
|---|---|---|---|
| Sample | (MPa) | at yield (MPa) | at yield (%) |
| OS-GE07 | 3 ± 1 | 7 ± 1 | 330 ± 80 |
| OS-GE08 | 10 ± 3 | 10 ± 2 | 120 ± 40 |

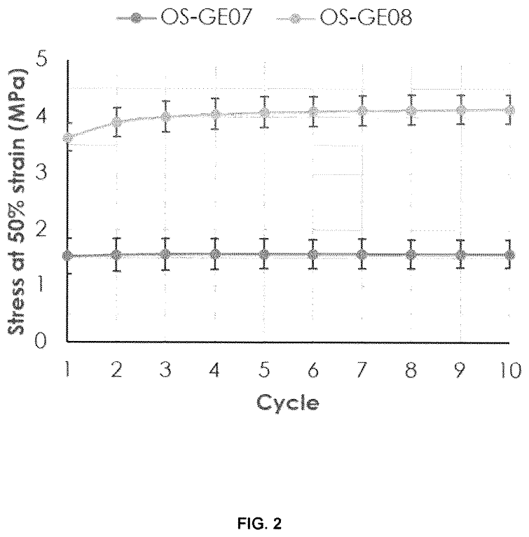

(2) Cyclability. Testing showed that the stress required to stretch the test materials to 50% strain did not decrease in 10 cycles (FIG. 2). This result shows that the elastic force wass maintained over cycles. This observation is on par with spandex for which 95% of elastic strain is maintained over cycles.

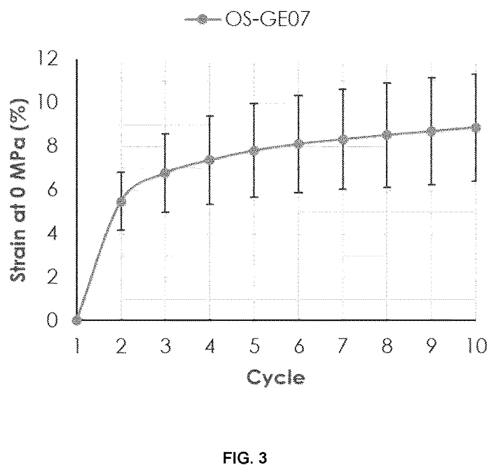

(3) Elastic recovery. Testing also showed that the test materials did not instantaneously return to their original length after a stretch-relax cycle (FIG. 3). This hysteresis did accumulate over 10 cycles, indicating that the recovery time was longer than the few seconds allowed by the test. The observed values are on par with some spandex fibers and textiles. The tensile set of the materials can also be measured following a procedure based on ASTM D412.

### Example 4. Origin and End of Life of Raw Materials

Citric acid. Citric acid is abundant in citrus fruits such as oranges, limes, and lemons. Its concentration in the latter can reach up to 300 mmol/L. Although abundant in citrus fruits, citric acid is a ubiquitous compound. For example, it is an intermediate in the Krebs Cycle (also known as the Tricarboxylic acid or TCA cycle) which allows generation of energy from the oxidation of AcetylCOA either by anaerobic or aerobic respiration. It is produced industrially either by extraction from lemon juice or by fungal fermentation with mold strains such as Penicillium or Aspergillus niger. Fungal fermentation is generally the favored production pathway since it is a fast and cheap route that can be performed from carbohydrate or industrial residues (such as corn steep liquor).

Sebacic acid. Sebacic acid is a naturally occurring dicarboxylic acid. It is obtained from the alkaline cleavage of rinoleic acid under pressure. Rinoleic acid is the main component of castor oil (comprising up to 87% of its composition). Castor oil is extracted from castor beans.

Octanediol-1,8. Octanediol is produced by hydrogenation of suberic acid. Suberic acid occurs naturally in cork bark. Industrially, suberic acid is produced mainly from cyclooctene which is a petroleum-based compound. However, suberic acid can also be produced from bio-based materials by ozonolysis of palmitic acid or from cleavage of rinoleic acid by nitrous treatment.

Decanediol-1,10. This compound is produced industrially by hydrogenation of sebacic acid.

### Example 5. Production of Foam from a Bio-Elastomer of the Disclosure

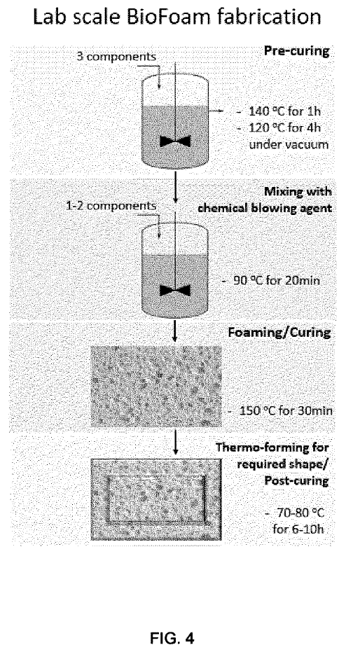

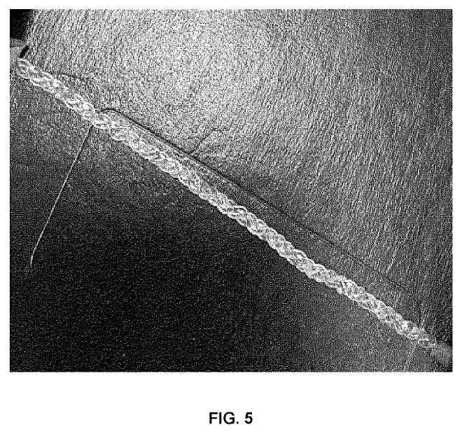

Method. The method used to make a Foam from a test bio-elastomer of the disclosure is shown schematically in FIG. 4. First, Citric acid, Sebacic acid, and Octanediol were mixed in equimolar proportions and heated for pre-curing as indicated in the first step in FIG. 4. Thereafter, basking soda was introduced as a blowing agent to create pores. The resulting slap was cured in the oven as per step 3 of FIG. 4 and finally thermoformed to a desired shape. A photograph of such a foam is shown in FIG. 5.

### Example 6. Preparation of Foams from Bio-Elastomers of the Disclosure

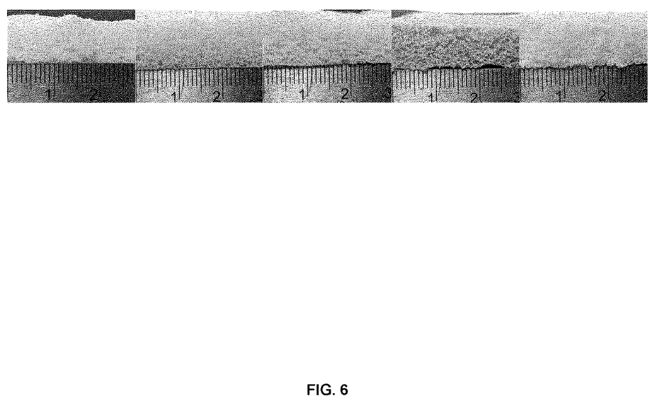

Foams were prepared from bio-elastomers of the disclosure, as described in Tables 3 and 4. Photographs of exemplary foams made as described in Table 3 are shown in FIG. 6, which shows, from left to right, Foam 1, Foam 2, Foam 3, Foam 4, and Foam 5.

TABLE 3
Exemplary foams prepared from bio-elastomers of the
disclosure, in accordance with certain embodiments.

| Foam | | 1 | | 2 | |
|---|---|---|---|---|---|
| Composition | | C12 (0.50) − Cit.A(0.25)/Suc.A(0.25) | | C12 (0.50) − Cit.A(0.25)/Suc.A(0.25) | |
| Preparation quantity | | 56 | g | 56 | g |
| Formulation | Monomers | C12: Dodecanediol (50% molar) | | C12: Dodecanediol (50% molar) | |
| | | Cit.A: Citric acid (25% molar) | | Cit.A: Citric acid (25% molar) | |
| | | Suc.A: Succinic acid (25% molar) | | Suc.A: Succinic acid (25% molar) | |
| | Catalyst | TEH [1.4 wt-%] | | TEH [1.4 wt-%] | |
| | | H₂SO₄ [0.23 wt-%] | | H₂SO₄ [0.23 wt-%] | |
| | Foaming | Sodium bicarbonate [6.5 wt-%] | | Sodium bicarbonate [6.5 wt-%] | |
| | agent | | | | |
| | Additives | IRGANOX ® 1076: antioxydant | | IRGANOX ® 1076: antioxydant | |
| | | TiO₂: Co-catalyst for TEH | | TiO₂: Co-catalyst for TEH | |
| | | Kaolin: nucleating agent | | Kaolin: nucleating agent | |
| | | Emulsion (o/w): castor oil, Tween 80, | | Emulsion (o/w): castor oil, Tween 80, | |
| | | Span 85, water | | Span 85, water | |
| Prepolymer | Step 1 | Monomers (3) melting conditions: | | Monomers (3) melting conditions: | |
| preparation | | Time: 37 min | | Time: 37 min | |
| | | Temperature: 275° C. (hotplate) | | Temperature: 275° C. (hotplate) | |
| | Step 2 | Dispersion of fillers in the melt, mix for | | Dispersion of fillers in the melt, mix for | |
| | | 5 min | | 5 min | |
| | | Kaolin | | Kaolin | |
| | | TiO₂ | | TiO₂ | |
| | Step 3 | Add catalyst: | | Add catalyst: | |
| | | 0.45% (30 drops) of TEH | | 0.45% (30 drops) of TEH | |
| | Step 4 | Apply vacuum and sequential adding | | Apply vacuum and sequential adding | |
| | | of catalysts: | | of catalysts: | |
| | | Time: 50 min | | Time: 50 min | |
| | | Temperature: 275° C. (hotplate) | | Temperature: 275° C. (hotplate) | |
| | | 15 min: 0.45% (30 drops) TEH | | 15 min: 0.45% (30 drops) TEH | |
| | | 20 min: 0.23% (12 drops) H₂SO₄ | | 20 min: 0.23% (12 drops) H₂SO₄ | |
| | | 30 min: 0.23% (15 drops) TEH | | 30 min: 0.23% (15 drops) TEH | |
| | | 37 min: 0.23% (15 drops) TEH | | 37 min: 0.23% (15 drops) TEH | |
| | Step 5 | Add foaming agent and additives: | | Add foaming agent and additives: | |
| | | Break vacuum | | Break vacuum | |
| | | Cool down, around 100° C. | | Cool down, around 100° C. | |
| | | Add emulsion w/o, mix. | | Add emulsion w/o, mix. | |
| | | Add sodium bicarbonate, mix. | | Add sodium bicarbonate, mix. | |
| Foaming | Curing | Curing in rectangular silicone pan, | | Curing in rectangular silicone pan, | |
| conditions | environment | top-open mold | | top-open mold | |
| | | Surface treatment of the pan with | | Surface treatment of the pan with | |
| | | castor oil | | castor oil | |
| | | Fumehood oven | | Fumehood oven | |
| | Curing time | 75 | min | 75 | min |
| | Curing | 165-175° | C. | 165-175° | C. |

| | | | |
|---|---|---|---|
| | temperature | | |
| Observations | | Can increase stiffness by adding | Can increase stiffness by adding |
| | | calcium phosphate | calcium phosphate |
| | | Can reduce density by increasing | Can reduce density by increasing |
| | | blowing agent concentration | blowing agent concentration |

TABLE 4
Exemplary foams prepared from bio-elastomers of the
disclosure, in accordance with certain embodiments.

| Foam | | 3 | | 4 | | 5 | |
|---|---|---|---|---|---|---|---|
| Composition | | C12 (0.50) − | | C12 (0.50) − | | C12 (0.50) − | |
| | | Cit.A(0.25)/Suc.A(0.25) | | Cit.A(0.25)/Suc.A(0.25) | | Cit.A(0.25)/Suc.A(0.25) | |
| Preparation quantity | | 56 | g | 56 | g | 56 | g |
| Formulation | Monomers | C12: Dodecanediol | | C12: Dodecanediol | | C12: Dodecanediol | |
| | | (50% molar) | | (50% molar) | | (50% molar) | |
| | | Cit.A: Citric acid | | Cit.A: Citric acid | | Cit.A: Citric acid | |
| | | (25% molar) | | (25% molar) | | (25% molar) | |
| | | Suc.A: Succinic acid | | Suc.A: Succinic acid | | Suc.A: Succinic acid | |
| | | (25% molar) | | (25% molar) | | (25% molar) | |
| | Catalyst | TEH [1.4 wt-%] | | TEH [1.4 wt-%] | | TEH [1.4 wt-%] | |
| | | H₂SO₄ [0.23 wt-%] | | H₂SO₄ [0.23 wt-%] | | H₂SO₄ [0.23 wt-%] | |
| | Foaming | Sodium bicarbonate | | Sodium bicarbonate | | Sodium bicarbonate | |
| | agent | [7.0 wt-%] | | [7.0 wt-%] | | [7.0 wt-%] | |
| | Additives | IRGANOX ® 1076: | | IRGANOX ® 1076: | | IRGANOX ® 1076: | |
| | | antioxydant | | antioxydant | | antioxydant | |
| | | TiO₂: Co-catalyst for | | TiO₂: Co-catalyst for | | TiO₂: Co-catalyst for | |
| | | TEH | | TEH | | TEH | |
| | | Kaolin: nucleating | | Kaolin: nucleating | | Kaolin: nucleating | |
| | | agent | | agent | | agent | |
| | | Calcium phosphate: | | Calcium phosphate: | | Calcium phosphate: | |
| | | increase stiffness | | increase stiffness | | increase stiffness | |
| | | (avoid collapsing) | | (avoid collapsing) | | (avoid collapsing) | |
| | | Emulsion (o/w): | | Emulsion (o/w): | | Emulsion (o/w): | |
| | | castor oil, Tween 80, | | castor oil, Tween 80, | | castor oil, Tween 80, | |
| | | Span 85, water | | Span 85, water | | Span 85, water | |
| Prepolymer | Step 1 | Monomers (3) melting | | Monomers (3) melting | | Monomers (3) melting | |
| preparation | | conditions: | | conditions: | | conditions: | |
| | | Time: 30 min | | Time: 35 min | | Time: 35 min | |
| | | Temperature: 275° C. | | Temperature: 275° C. | | Temperature: 275° C. | |
| | | (hotplate) | | (hotplate) | | (hotplate) | |
| | Step 2 | Dispersion of fillers in | | Dispersion of fillers in | | Dispersion of fillers in | |
| | | the melt, mix for 5 min | | the melt: | | the melt: | |
| | | Kaolin | | Kaolin | | Kaolin | |
| | | TiO2 | | TiO2 | | TiO2 | |
| | Step 3 | Add catalyst: | | Add catalyst: | | Add catalyst: | |
| | | 0.45% (xx drops) of | | 0.46% (13 drops) of | | xx % (xx drops) of | |
| | | TEH | | TEH | | TEH | |
| | Step 4 | Apply vacuum and | | Apply vacuum and | | Apply vacuum and | |
| | | sequential adding of | | sequential adding of | | sequential adding of | |
| | | catalysts: | | catalysts: | | catalysts: | |
| | | Time: 49 min | | Time: 35 min | | Time: 28 min | |
| | | Temperature: 275° C. | | Temperature: 275° C. | | Temperature: 275° C. | |
| | | (hotplate) | | (hotplate) | | (hotplate) | |
| | | 15 min: 0.45% (30 | | 06 min: 0.46% (13 | | 05 min: 0.46% (13 | |
| | | drops) TEH | | drops) TEH | | drops) TEH | |
| | | 20 min: 0.23% (12 | | 10 min: 0.22% (5 | | 10 min: 0.23% (5 | |
| | | drops) H2SO4 | | drops) H2SO4 | | drops) H2SO4 | |
| | | 32 min: 0.23% | | 15 min: 0.23% (7 | | 15 min: 0.23% (7 | |
| | | (15 drops) TEH | | drops) TEH | | drops) TEH | |
| | | 37 min: 0.23% (15 | | 25 min: 0.23% (7 | | 25 min: 0.23% (7 | |
| | | drops) TEH | | drops) TEH | | drops) THE | |
| | Step 5 | Add foaming agent | | Add foaming agent | | Add foaming agent | |
| | | and additives: | | and additives: | | and additives: | |
| | | Break vacuum | | Break vacuum | | Break vacuum | |
| | | Cool down, around | | Cool down, around | | Cool down, around | |
| | | 100° C. | | 100° C. | | 100° C. | |
| | | Add emulsion w/o, | | Add emulsion w/o, | | Add emulsion w/o, | |
| | | mix. | | mix. | | mix. | |
| | | Add calcium | | Add calcium | | Add calcium | |
| | | phosphate (1.5 wt-%), | | phosphate (1.8 wt-%), | | phosphate (1.8 wt-%), | |
| | | mix. | | mix. | | mix. | |
| | | Add sodium | | Add sodium | | Add sodium | |
| | | bicarbonate, mix. | | bicarbonate, mix. | | bicarbonate, mix. | |
| Foaming | Curing | Cating in rectangular | | Cating in rectangular | | Cating in: 1) MAS | |
| conditions | environment | silicone pan, top-open | | silicone pan, top-open | | bra-cap mold | |
| | | mold | | mold | | 2) | |
| | | Surface treatment of | | Surface treatment of | | Silicone pan | |
| | | the pan with castor oil | | the pan with castor oil | | (reference) | |
| | | Fumehood oven | | Fumehood oven | | Surface treatment of | |
| | | | | | | the mold with castor | |
| | | | | | | oil | |
| | | | | | | Fumehood oven and | |
| | | | | | | outside oven | |
| | Curing time | 160 | min | 110 | min | 40-45 | min |
| | Curing | 160-170° | C. | 160-165° | C. | 160-165° | C. |

| | | | | |
|---|---|---|---|---|
| | temperature | | | |
| Observations | | Can reduce viscosity | Foam was dyed to | Can increase |
| | | by reducing vacuum | make blue foam | stiffness by increasing |
| | | time | | calcium phosphate |

Although this invention is described in detail with reference to embodiments thereof, these embodiments are offered to illustrate but not to limit the invention. It is possible to make other embodiments that employ the principles of the invention and that fall within its spirit and scope as defined by the claims appended hereto.

Based upon the foregoing, those skilled in the art will readily recognize that various modifications and changes may be made to the various embodiments without strictly following the exemplary embodiments and applications illustrated and described herein. Such modifications do not depart from the true spirit and scope of various aspects of the disclosure, including aspects set forth in the claims.

The contents of all documents and references cited herein are hereby incorporated by reference in their entirety.

What is claimed is:

1. A stretchable polymer made from reacting one or more di-alcohols with a di-acid or tri-acid, followed by curing at high temperatures.

2. A stretchable polymer made from reacting a di-alcohol with a di-acid in the presence of a crosslinking agent comprising both a thermal initiator and a photoinitiator, followed by extrusion and subsequent curing with ultraviolet light (UV).

3. The stretchable polymer of claim 2, wherein the crosslinking agent is itaconic acid, maleic acid, maleic anhydride, or a combination thereof.

4. The stretchable polymer of any one of claims 1 to 3, wherein the polymer demonstrates an elongation ratio of at least 50%.

5. The stretchable polymer of any one of claims 1 to 4, wherein the polymer demonstrates a maximum elongation ratio of 1000%.

6. The stretchable polymer of any one of claims 1 to 5, wherein the polymer has a tenacity of at least 5 g/denier.

7. The stretchable polymer of any one of claims 1 to 6, wherein the polymer recovers its original length fully upon removal of stress.

8. The stretchable polymer of any one of claims 1 to 7, wherein the polymer can undergo at least 100 cycles of relaxation and elongation without any fatigue.

9. The stretchable polymer of any one of claims 1 to 8, wherein the di-alcohol is 1.4 butanediol pentanediol, hexanediol, octanediol, decanediol or dodecanediol.

10. The stretchable polymer of any one of claims 1 to 9, wherein the di-acid is sebacic acid, succinic acid, adipic acid, lactic acid, or boric acid.

11. The stretchable polymer of any one of claims 1 to 10, further comprising a crosslinking agent.

12. The stretchable polymer of claim 11, wherein the crosslinking agent is citric acid or boronic acid.

13. The stretchable polymer of claim 11, wherein the crosslinking agent is itaconic acid, maleic acid or maleic anhydride.

14. The stretchable polymer of claim 11 or 13 wherein the crosslinking agent contains an unsaturated bond that can be activated thermally and/or through UV.

15. The stretchable polymer of any one of claims 11, 13 and 14, wherein the polymer comprises:
one or more di-acid;
one or more di-alcohol; and
a crosslinking agent comprising a thermal initiator and a photoinitator, wherein the crosslinking agent is itaconic acid or maleic acid;
wherein the polymer is formed by:
(i) reacting the one or more di-alcohol and the one or more di-acid to form a polyester;
(ii) pelletising the polyester and then melting or solution extruding the pelleted polyester to form a thermoplastic fiber;
(iii) exposing the thermoplastic fiber to a UV chamber for at least a few minutes to activate an unsaturated double bond and create a crosslink, thereby forming an elastomeric fiber of the polymer.

16. The stretchable polymer of claim 15, wherein the elastomeric fiber has an elongation of at least 200% and is an ultra thin fiber of at least 40 denier, formed via melt or dry spinning.

17. The stretchable polymer of any one of claims 1 to 16, wherein the polymer is in the form of a melt extruded fiber suitable for conversion into a knit or woven fabric.

18. The stretchable polymer of any one of claims 15 to 17, wherein the fiber is blended with cotton, polyester or nylon.

19. The stretchable polymer of any one of claims 15 to 18, wherein the fiber has one or more of the following properties:
capable of being converted into a knit or woven fabric having high stretch, for example an elongation of at least 200% and full elastic recovery; and
capable of being separated into monomers using media at high pH, for example pH of 11 to 13, wherein the monomers can be reused for spinning a new fiber, thereby allowing recycling of the polymer.

20. The stretchable polymer of any one of claims 1 to 19, further comprising one or more reinforcing agent which is added to improve stiffness and/or resistance to breaking.

21. The stretchable polymer of claim 20, wherein the one or more reinforcing agent comprises microcrystalline cellulose, nanocrystalline cellulose, titanium dioxide, kaolin, silica, nanoclay, carbon black, or a combination thereof.

22. The stretchable polymer of any one of claims 1 to 21, wherein the polymer is blended with a carrier polymer to obtain a viscosity and consistency suitable for processability into fibers or foams.

23. The stretchable polymer of claim 22, wherein the carrier polymer is cellulose, a cellulose derivative, poly(lactic acid), polycaprolactam, starch, or another biopolymer.

24. The stretchable polymer of any one of claims 1 to 23, wherein the polymer can be processed into fibers via melt spinning, solution spinning, electrospinning or melt blowing.

25. The stretchable polymer of any one of claims 1 to 24, wherein the polymer can be formed as ultra thin fibers, for example fibers of at least 40 denier, via melt or dry spinning.

26. The stretchable polymer of claim 24, wherein said fibers have dimensions ranging from 50 deniers to 150 denier.

27. The stretchable polymer of any one of claims 24 to 26, wherein said fibers can be woven or knit with cotton, polyester or other fibers to form a stretch fabric.

28. The stretchable polymer of claim 27, wherein the stretch fabric remains intact with no loss of mass or physical properties after 25 wash, rinse and/or drying cycles.

29. The stretchable polymer of any one of claims 1 to 28, wherein the polymer can be molded into objects via injection molding or 3D printing.

30. The stretchable polymer of any one of claims 1 to 29, wherein the polymer can be made into a cellular structure or a foam through introduction of blowing agents.

31. The stretchable polymer of claim 30, wherein the polymer is thermoformable at elevated temperatures.

32. The stretchable polymer of any one of claims 1 to 31 wherein the polymer is made partially or entirely of plant-derived molecules.

33. The stretchable polymer of any one of claims 1 to 32, wherein the polymer is fully biodegradable at the end of its life.

34. The stretchable polymer of any one of claims 1 to 33, wherein the polymer is fully compostable at the end of its life.

35. The stretchable polymer of any one of claims 1 to 34, wherein the polymer is fully recyclable at the end of its life.

36. The stretchable polymer of any one of claims 1 to 35, wherein the polymer can be separated from a blend via an increase in pH.

37. The stretchable polymer of claim 36, wherein the increase in pH causes hydrolysis of the polymer into its monomers.

38. The stretchable polymer of claim 37, wherein the monomers can further react to form a new polymer.

39. The stretchable polymer of any one of claims 36 to 38, wherein the polymer is recyclable.

40. The stretchable polymer of any one of claims 1 to 39, wherein the polymer is suitable for use in place of fibers in garments, undergarments, automobile interiors, medical textiles and/or wound dressings.

41. The stretchable polymer of any one of claims 1 to 39, wherein the polymer is suitable for use in place of polyurethane foam in insulation, packaging and garment applications.

42. The stretchable polymer of any one of claims 1 to 39, wherein the polymer is suitable for use in place of poly(dimethyl silicone) in molded elastomeric objects.

43. The stretchable polymer of claim 42, wherein the molded elastomeric objects are phone cases, sealants or household items.

44. The stretchable polymer of claim 43, wherein the household items are bed mattresses or furniture.

45. The stretchable polymer of any one of claims 1 to 44, wherein the polymer comprises polyglycerol sebacate (PGS) or polyoctanediol citrate (POC):

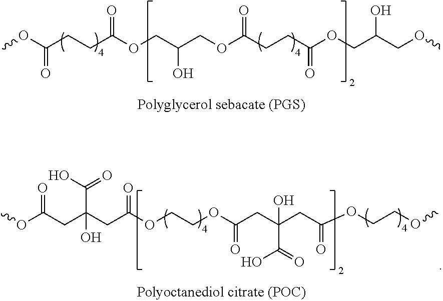

46. The stretchable polymer of any one of claims 22 to 45, wherein the carrier polymer is cellulose acetate (CA):

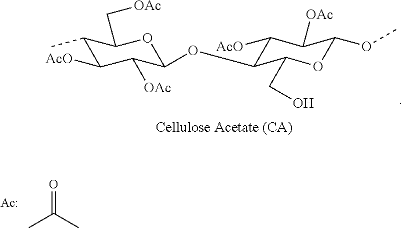

47. A fiber comprising the stretchable polymer of any one of claims 1 to 46.

48. A foam comprising the stretchable polymer of any one of claims 1 to 46.

49. A molded object comprising the stretchable polymer of any one of claims 1 to 46.

50. An article comprising the stretchable polymer of any one of claims 1 to 46, the fiber of claim 47, the foam of claim 48, or the molded object of claim 49.

51. The article of claim 50, wherein the article is a garment, an undergarment, an automobile interior, a medical textile, a wound dressing, insulation, packaging, a phone case, a sealant, a household item, a bed mattress, or furniture.

52. The article of claim 50, wherein the article is a knit or woven fabric.

53. The article of claim 52, wherein the knit or woven fabric is a stretch fabric.

54. A biodegradable, compostable, and bio-based elastomeric fiber which has an elongation ratio of at least 50% and a maximum elongation ratio of 1000%, can recover its original length fully upon removal of stress, and can undergo at least 100 cycles of relaxation and elongation without any fatigue.

55. The elastomeric fiber of claim 54, wherein the polymer has a tenacity of at least 5 g/denier and/or wherein the fiber has a denier size of at least 40.

56. The elastomeric fiber of claim 54 or 55, comprising a di-alcohol reacted with a di acid or tri-acid and cured at high temperatures.

57. The elastomeric fiber of any one of claims 54 to 56, comprising polyglycerol sebacate (PGS) or polyoctanediol citrate (POC), and optionally further comprising a carrier polymer which is cellulose acetate (CA).

58. The elastomeric fiber of any one of claims 54 to 57, comprising a combination of a plurality of di-acids and di-alcohols which are esterified together.

59. The elastomeric fiber of claim 58, wherein said esterification prevents crystallization and/or maximises elongation of the fiber.

60. The elastomeric fiber of claim 58 or 59, wherein the plurality of di-alcohols comprises propandiol and/or 1,4 butandiol.

61. The elastomeric fiber of any one of claims 58 to 60, wherein the plurality of di-acids comprises sebacic acid and/or succinic acid.

62. A method for making the elastomeric fiber of any one of claims 54 to 61, comprising:
combining equimolar amounts of octanediol, sebacic acid and citric acid and melting at 80 degrees C. to a honey-like consistency, to form a molten precursor;
plasticizing cellulose acetate with triethyl citrate and combining with the molten precursor, to form a melt; and
passing the melt through an extruder and a spinneret and drawing into fibers.

63. A method for making a foam structure comprising the elastomer of any one of claims 54 to 61, comprising:
combining equimolar amounts of octanediol, sebacic acid and citric acid and melting at 80 degrees C. to form a partially cured poly(octanediol citrate sebacate);
hot pressing the partially cured poly(octanediol citrate sebacate) containing baking soda with a cellulose acetate mold into a desired shape;
heating so that the baking soda reacts with the citric acid to create pores, thereby forming a foam structure.

64. The method of claim 63, further comprising addition of a surfactant to ensure uniform distribution of pores in the foam structure.

65. The method of claim 64, wherein the surfactant is castor oil.

66. The method of claim 64 or 65, wherein the foam structure has elongation at break of at least 150% with full elastic recovery.

67. A method for making the elastomeric fiber of any one of claims 54 to 61, comprising:
reacting a plurality of di-acids and di-alcohols together in the presence of a crosslinking agent to form a polyester, wherein the crosslinking agent comprises both a thermal initiator and a photoinitiator;
pelletising the polyester and then melting or solution extruding the pelleted polyester to form a thermoplastic fiber; and
exposing the thermoplastic fiber to a UV chamber for a time sufficient to activate an unsaturated double bond in the crosslinking agent and create a crosslink, thereby producing the elastomeric fiber.

68. The method of claim 67, wherein the crosslinking agent is itaconic acid, maleic acid or a combination thereof.

69. The method of claim 67 or 68, wherein the di-alcohols comprise propandiol, 1,4 butandiol, or a combination thereof.

70. The method any one of claims 67 to 69, wherein the di-acids comprise sebacic acid, succinic acid, or a combination thereof.

71. The method of any one of claims 67 to 70, wherein the plurality of di-acids and di-alcohols are esterified together, thereby preventing crystallization and/or maximising elongation.
